(19) United States
(12) Patent Application Publication
(10) Pub. No.: US 2014/0142816 A1
(43) Pub. Date: May 22, 2014

(54) METHOD FOR OPERATING A VEHICLE AND VEHICLE

(71) Applicant: GM GLOBAL TECHNOLOGY OPERATIONS LLC, Detroit, MI (US)

(72) Inventor: Marco MOEBUS, Mainz (DE)

(73) Assignee: GM GLOBAL TECHNOLOGY OPERATIONS LLC, Detroit, MI (US)

(21) Appl. No.: 14/081,298

(22) Filed: Nov. 15, 2013

(30) Foreign Application Priority Data
Nov. 15, 2012 (DE) 10 2012 022 321.8

(51) Int. Cl. B60R 16/023

(52) U.S. Cl. CPC B60R 16/0231
USPC 701/49; 701/1; 701/70; 701/36

(57) ABSTRACT

A method is provided for operating a vehicle. The method comprises determining whether at least one occupant of the vehicle is moving at least one body part based on data collected by at least one ultrasonic sensor arranged in the vehicle. If it is determined that at least one occupant of the vehicle is moving at least one body part, the movement is classified based on the data collected by the at least one ultrasonic sensor and a determination is made as to whether the movement corresponds to a predefined movement type from a plurality of predefined movement types. If it is determined that at the movement corresponds to a predefined movement type from a plurality of predefined movement types, at least one component of the vehicle is adapted automatically depending on the predefined movement type.

### CROSS-REFERENCE TO RELATED APPLICATION

This application claims priority to German Patent Application No. 10 2012 022 321.8, filed Nov. 15, 2012, which is incorporated herein by reference in its entirety.

### TECHNICAL FIELD

The technical field relates to a method for operating a vehicle, a vehicle, a software product, and a computer readable medium.

### BACKGROUND

A method and device for warning a driver of a vehicle about a source of danger in the vicinity of the vehicle. The vehicle comprises a detecting device for detecting the danger source and the direction in which the danger source is located is known from DE 10 2007 045 932 A1. Upon detection of a source of danger, at least a first optical warning signal is displayed in the driver's current field of vision, and this first optical warning signal contains at least an indication of the direction of the danger source relative to the driver.

At least one problem addressed by the application is to provide a method for operating a vehicle, a vehicle, a software product and a computer readable medium that enables further improved account to be taken of a current behaviour of occupants of the vehicle for the purpose of operating the vehicle. In addition, other objects, desirable features and characteristics will become apparent from the subsequent summary and detailed description, and the appended claims, taken in conjunction with the accompanying drawings and this background.

### SUMMARY

According to embodiment, a method is provided for operating a vehicle comprises the following steps. A determination is made as to whether at least one occupant of the vehicle is moving at least one body part, based on data collected by at least one ultrasonic sensor disposed inside the vehicle, and the movement is then classified on the basis of the data collected by the at least one ultrasonic sensor. A determination is also made as to whether the movement corresponds to a predefined movement type from a plurality of predefined movement types. If it is determined that the movement corresponds to a predefined movement type from a plurality of predefined movement types, at least one component of the vehicle is adapted automatically depending on the classification of the predefined movement type.

The method according to the embodiment described enables better account to be taken of a current behaviour of the occupants of a vehicle for the purpose of operating the vehicle. This is enabled particularly by determining whether at least one occupant of the vehicle is moving at least one body part, and classifying each movement based on data collected by the at least one ultrasonic sensor and the automatic adaptation of at least one component of the vehicle if the identified movement corresponds to a predefined movement type. In this context, the basis for the approach is the consideration that the body movements made by vehicle occupants enable conclusions to be drawn about their current behavior.

Accordingly, components of the vehicle may then be adapted automatically on the basis of the detected and classified movement. In this way, traffic safety and/or user comfort while the vehicle is in operation may be improved, as will be explained in the following. The determination as to whether an occupant of the vehicle is moving at least one body part and the classification of such possible movement may then be made advantageously at little cost through the use of the at least one ultrasonic sensor, since such ultrasonic sensors are in particular less expensive than optical cameras. Moreover, ultrasonic sensors are able to interpret depth information, that is to say spatial information, quite simply, whereas greater effort is required to obtain such information with optical systems.

In addition, more options are available for installing the at least one ultrasonic sensor in the vehicle than for installing an optical camera, which means that the position of the ultrasonic sensor can be selected more flexibly than the position of an optical camera. The movements or gestures made by the vehicle occupants may thus be determined and classified inexpensively and more effectively by installing the at least one ultrasonic sensor.

The determination as to whether at least one occupant of the vehicle is moving at least one body part preferably includes a step of determining whether a driver of the vehicle is moving at least one body part. The current behaviour of the vehicle driver is of particular importance for the current driving operation of the vehicle, in particular for traffic safety. For example, by determining and classifying movements made by the driver, it may be concluded that the driver is in a state of reduced awareness in the current driving situation, and the operation of the vehicle may be adapted appropriately, as will be explained in the following.

In a further embodiment, the determination as to whether at least one occupant is moving at least one body part includes determining a movement selected from the group consisting of a head movement, eye movement, hand movement, leg movement, or upper body movement. In this variant, it is thus determined whether at least one occupant of the vehicle is moving at least one body part selected from the group consisting of the head, eyes, hands, legs and upper body.

The movement types described are particularly helpful for drawing a conclusion about the level of awareness of the respective occupants. In this way, a possible momentary distraction may be determined on the basis of said movement types, for example if the driver looks away from the immediate traffic environment. Or, a conclusion may particularly be drawn as to whether the vehicle driver is no longer operating an accelerator, that is to say he has removed his foot from the accelerator or is operating the brake pedal, on the basis of leg movements or leg positions and/or leg posture.

The determination as to whether at least one occupant is moving at least one body part and/or the classification of the movement is preferably carried out with pattern recognition in the data collected by the at least one ultrasonic sensor. The determination as to whether at least one occupant of the vehicle is moving at least one body part and/or the classification of the movement may further include analysis of a chronological progression of a distance of the body part from the at least one ultrasonic sensor and/or of a direction of motion of the body part based on the data collected by the at least one ultrasonic sensor. For example, the chronological progression of the distance may be deduced from a change in the frequency of the ultrasonic waves, also called the micro-Doppler effect, and/or phase changes of the ultrasonic waves. Said embodiments thus enable the respective movements to be determined or classified simply and reliably.

In a further variation of the method, the automatic adaptation of the at least one component of the vehicle includes automatic adaptation of at least one driver assistance system of the vehicle. In this context, the at least one driver assistance system is preferably designed to operate at least one element of the vehicle selected from the group consisting of a braking device, a drive unit, a steering device and a warning device. In this variation, the adaptation of the at least one driver assistance system includes the modification of a threshold value for the automatic operation of the at least one element in such manner that automatic operation takes place sooner compared with the previous threshold value.

In this case, as was explained previously, the approach is based on the consideration that certain movement types allow the conclusion to be drawn that the occupant, in particular the driver, is experiencing a reduced level of awareness. In such situations, the variant described enables earlier output of a warning signal or early autonomic intervention in the driving dynamics of the vehicle, by which means traffic safety may be advantageously improved. To this end, the at least one driver assistance system is selected from the group consisting of an emergency braking system, a braking assistant, a lane tracking assistant and a collision warning system.

In a further embodiment of the method, the automatic adaptation of the at least one component of the vehicle includes automatic adaptation of at least one control element and/or at least one display element of the vehicle. In this context, the basis for the approach is the consideration that certain types of movement by the occupant allow the conclusion to be drawn that an operation of control elements is imminent, for example a hand movement, or that a conclusion may be drawn regarding the direction in which the occupant is currently looking, for example a movement of the head. Accordingly, in the cases described, control elements of which operation is imminent or display elements that are currently located in the direction in which the occupant is looking may be adapted.

In addition, automatic adaptation preferably includes automatic activation of the at least one control element and/or the at least one display element. For example, an input element of the control element may be activated automatically, particularly if the control element comprises a touch-sensitive display device. Also, if the control element is covered by a protective panel, the panel may be moved so that the control element may be operated if it is determined that a hand or arm movement is being made toward the panel.

Additionally, the automatic adaptation may be an automatic adaptation of the luminosity of a lighting device of the at least one control element and/or the at least one display element. In particular, the luminosity of the lighting device may be increased if imminent operation of the control element is determined on the basis of the interpreted movement, or if it is determined that the at least one display element is positioned in the direction in which the occupant is currently looking. In addition, the automatic adaptation may also include automatic adaptation of a position of the at least one control element and/or the at least one display element in the vehicle. In this way, for example, an operation of the control element may be made easier for the occupant to carry out or the display element may be made more clearly perceptible by the occupant.

A vehicle is also provided that comprise at least one ultrasonic sensor. The at least one ultrasonic sensor is disposed inside the vehicle. The vehicle also comprises a first analysis device, which is designed to determine whether at least one occupant of the vehicle is moving at least one body part on the basis of the data collected by the at least one ultrasonic sensor. The vehicle further comprises a classification device that is designed to classify the movement on the basis of the data collected by the at least one ultrasonic device, if it is determined that at least one occupant of the vehicle is moving at least one body part.

The vehicle also comprises a second analysis device that is designed to determine whether the movement corresponds to a predefined movement type from a plurality of predefined movement types if it is determined that at least one occupant of the vehicle is moving at least one body part. Additionally, the vehicle comprises an adaptation device that is designed to automatically adapt at least one component of the vehicle depending on the predefined movement type, if it is determined that the movement corresponds to a predefined movement type from a plurality of predefined movement types.

The vehicle has the same advantages as were described in the description of the method, and these will not be listed again here in order to avoid repetition.

In one variant, the vehicle comprises a plurality of ultrasonic sensors arranged inside the vehicle, that is to say, in this variant the vehicle comprises at least two ultrasonic sensors arranged inside the vehicle. In particular, the vehicle may comprise multiple ultrasonic sensors that operable as a common sensor array, as a “phased array” for example, which enables the individual ultrasonic sensors to be arranged and controlled so that the sonic waves emitted thereby may be bundled and thus directed, that is to say the ultrasonic field is amplified in a desired direction and attenuated in an undesired direction. Phase shifted heterodyning of received individual signals makes it possible to achieve a corresponding directional effect for receiving the sonic waves as well. In this way, such a phased array advantageously enables directional or directed emission and reception of the sonic waves.

A software product is provided which, when running on a vehicle onboard computing unit, instructs the computing unit to carry out the following steps. The computing unit is instructed to determine whether at least one occupant of the vehicle is moving at least one body part based on data collected by at least one ultrasonic sensor arranged inside the vehicle. If it is determined that at least one occupant of the vehicle is moving at least one body part, the computing unit is instructed to classify the movement based on the data collected by the at least one ultrasonic sensor, and to determine whether the movement corresponds to a predefined movement type from a plurality of predefined movement types. If it is determined that the movement corresponds to a predefined movement type from a plurality of predefined movement types, the computing unit is instructed to automatically adapt at least one component of the vehicle depending on the predefined movement type identified.

A computer-readable medium is also provided on which a software product according to the embodiment described is stored. The software product and the computer-readable medium have the same advantages as were described in the description of the method, and these will not be listed again here in order to avoid repetition.

In the embodiments described, the vehicle is preferably in the form of a motor vehicle, for example a motor car or truck.

### BRIEF DESCRIPTION OF THE DRAWINGS

The present invention will hereinafter be described in conjunction with the following drawing figures, wherein like numerals denote like elements, and:

FIG. 1 shows a flowchart of a method for operating a vehicle according to an embodiment;

FIG. 2 shows a vehicle according to an embodiment; and

FIG. 3 shows details of the vehicle represented in FIG. 2.

### DETAILED DESCRIPTION

The following detailed description is merely exemplary in nature and is not intended to limit application and uses. Furthermore, there is no intention to be bound by any theory presented in the preceding background or summary or the following detailed description.

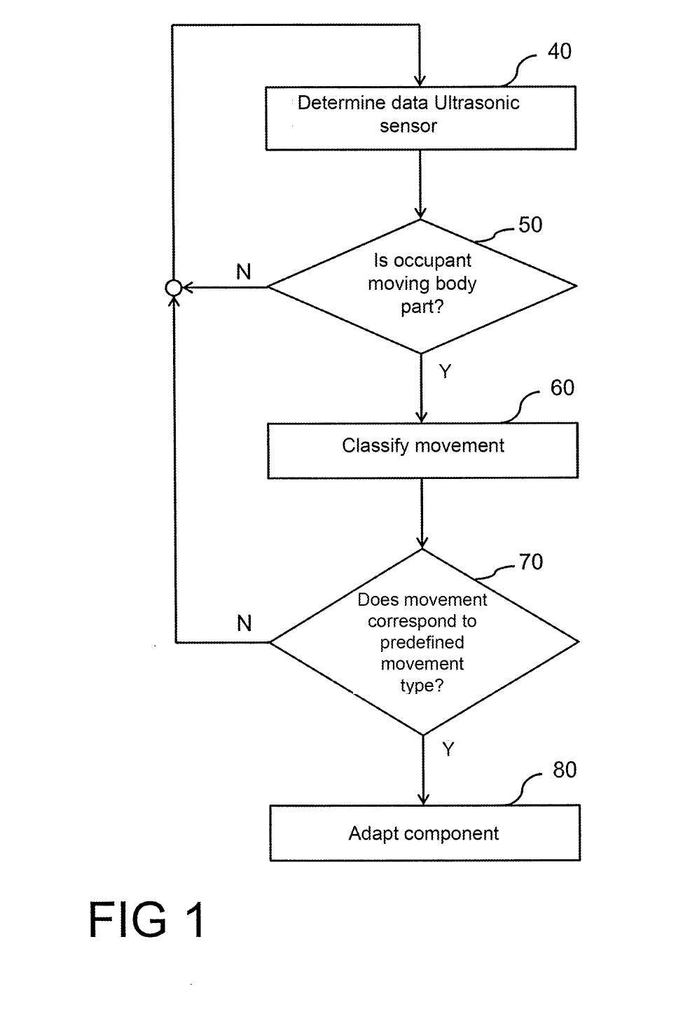

FIG. 1 shows a flowchart of a method for operating a vehicle according to an embodiment. The vehicle is preferably a motor vehicle, for example a motor car or truck. In a step 40, data is collected via at least one ultrasonic sensor arranged in the vehicle while the vehicle is being operated. The at least one ultrasonic sensor is preferably a component of the vehicle. The at least one ultrasonic sensor may also be a component of a mobile device that is located in the vehicle while the vehicle is in operation and is coupled thereto for example via a wireless connection. In such case, the at least one ultrasonic sensor is arranged inside the vehicle in such manner that at least one of the occupants of the vehicle, preferably the driver and/or the front seat passenger, is positioned at least partly within a detection range of the ultrasonic sensor.

In a step 50, it is determined on the basis of the data collected in step 40 whether at least one of the occupants of the vehicle who is positioned within a detection range of the ultrasonic sensor is moving at least one body part. This is carried out for example with pattern recognition in the data collected by the at least one ultrasonic sensor. Additionally for this purpose a chronological progression of a distance of the body part from the at least one ultrasonic sensor may be determined on the basis of the collected data. If the at least one occupant moves toward or away from the sensor may then be determined from the data collected using the “micro-Doppler effect”. A movement may also be determined on the basis of a changed position of the at least one body part in the detection range of the ultrasonic sensor.

The determination of the movement preferably includes determining a movement selected from the group consisting of a head movement, an eye movement, a hand movement, a leg movement and an upper body movement, that is to say the ultrasonic sensor is arranged inside the vehicle in such manner that the body parts described are within the detection range thereof

In this context, if it is determined in step 50 that none of the occupants in the detection range is moving, steps 40 and 50 are repeated. On the other hand, if it is determined in step 50 that at least one of the occupants within the detection range is moving at least one body part, in a step 60 the movement is classified on the basis of the data collected by the at least one ultrasonic sensor. The classification of the movement may in turn include the detection of patterns in the data collected by the at least one ultrasonic sensor and/or the interpretation of a chronological progression of a distance between the body part and the at least one ultrasonic sensor and/or of a direction of movement of the body part, using the micro-Doppler effect again. In particular, the classification of the movement may include classification of the movement according to the body part being moved, the duration of the movement, the amplitude of the movement, the direction of the movement, the current position of the body part that has been moved, and/or an expected position of the body part after it has been moved.

In a step 70, a determination is made as to whether the movement classified in step 60 corresponds to a predefined movement type from a plurality of predefined movement types. For example, the classified movement is compared for this purpose with the predefined, in other words default movements. If it is then determined that the movement does not correspond to any of the predefined movement types of the plurality of predefined movement types, steps 40, 50, and also 60 and 70 if applicable, are carried out repeatedly. For example, the described steps are carried out if it is determined that none of the body parts referred to in the preceding is moved or that the duration and/or amplitude of the movement does not exceed a respective threshold value.

On the other hand, if it is determined in step 70 that the movement does correspond to a predefined movement type from a plurality of predefined movement types, in a step 80 an automatic adaptation of at least one component of the vehicle is carried out depending on which predefined movement type is identified. The automatic adaptation of the at least one component includes for example an automatic adaptation of at least one driving assistance system of the vehicle. The at least one driving assistance system is preferably designed to automatically actuated at least one element of the vehicle selected from the group consisting of a braking device, a drive unit, a steering device and a warning device. If the predefined movement type characterizes a momentary lapse of concentration by the driver, a threshold value for the automatic actuation of the at least one element is adapted in such manner that the automatic actuation is carried out sooner compared with the current threshold value. The at least one driving assistance system is selected for example from the group consisting of an emergency braking system, a braking assistant, a lane tracking assistant and a collision warning system.

With the embodiment described, it is particularly possible to interpret the movement of the driver's head as a sign of alertness. In cases in which the driver turns his head, the driver is typically not alert, and assistant systems may adapt their warning and/or control strategy accordingly.

The automatic adaptation of the at least one component may also include automatic adaptation of at least one control element and/or at least one display element of the vehicle, in particular automatic activation of the at least one control element and/or of the at least one display element. Additionally, the luminosity of a lighting device of the at least one control element and/or the at least one display element may be adapted automatically. In a further variation, a position of the at least one control element and/or the at least one display element is also adapted automatically.

In a further variant of the method, besides the collection of data with at least one ultrasonic sensor, data is also collected with an optical camera. The at least one optical camera is arranged inside the vehicle, for example in the area of an interior mirror of the vehicle or centered in front of the driver, for example above an instrument cluster or combination instrument of the vehicle. In this variant of the method, the determination as to whether at least one occupant of the vehicle is moving at least one body part and/or the classification of the movement are made on the basis of the data collected by the at least one ultrasonic sensor and also based on the data collected be the at least one optical camera. In this way a fusion of data collected by multiple different sensors and thus a mutual plausibility check of the data collected is provided.

The embodiment described advantageously enables gesture recognition using acoustic signals, optionally in conjunction with optical signals, for example from an optical camera. In this way, gestures made particularly by a vehicle driver may be collected and classified as an indicator of the driver's level of alertness or as a sign of special actions, for the purpose of activating or adapting driver assistance systems in the vehicle, for example.

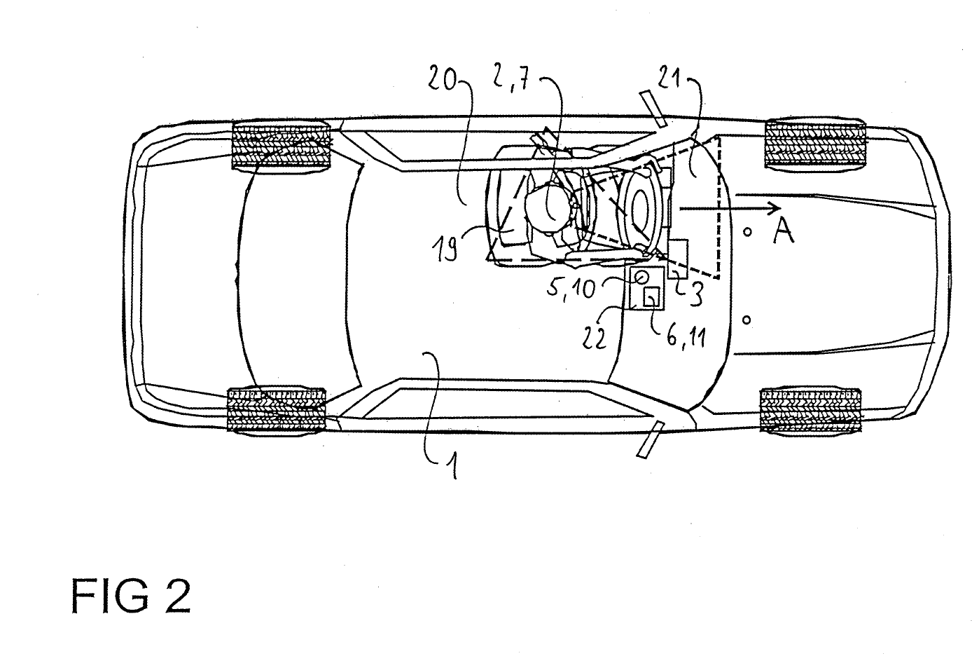

FIG. 2 shows a diagrammatic representation of a vehicle 1 according to an embodiment. In the embodiment shown, vehicle 1 is a vehicle in the form of a motor car, wherein in FIG. 2 a part of the roof of vehicle 1 has been omitted to show a passenger cabin 20 of vehicle 1 in greater detail. In the embodiment shown, vehicle 1 comprises an acoustic sensor in the form of at least one ultrasonic sensor 3, which is arranged in the area of an interior mirror, not further shown, in vehicle 1. Ultrasonic sensor 3 has a detection range 19, which is represented diagrammatically. An occupant 2 of vehicle 1, who is illustrated in the embodiment shown as a driver 7 of vehicle 1, is positioned at least partly within the detection range of 19 of ultrasonic sensor 3.

As will be explained in greater detail with reference to the following figure, the data collected by the at least one ultrasonic sensor 3 may serve as the basis for determining whether occupant 2 of vehicle 1 is moving at least one body part, and the movement may further be classified on the basis of the collected data. In this case, if the movement corresponds to a predefined movement type from a plurality of predefined movement types, at least one component of vehicle 1 will be adapted automatically depending on the predefined movement type. For this purpose, components 5 and 6 of vehicle 1 are shown in the form of a control element 10 and a display element 11 in FIG. 2. Control element 10 and display element 11 are arranged in the area of a centre console 22, represented diagrammatically, of vehicle 1.

Automatic adaptation of at least one driver assistance system of vehicle 1 may also be carried out if the movement corresponds to a predefined movement type from the plurality of predefined movement types. For example, adaptation of at least one driver assistance system of vehicle 1 may be effected if it is determined that driver 7 is turning his head in such manner that the direction in which driver 7 is looking is outside of a diagrammatically indicated range 21 that includes a current travel direction of vehicle 1, indicated by arrow A.

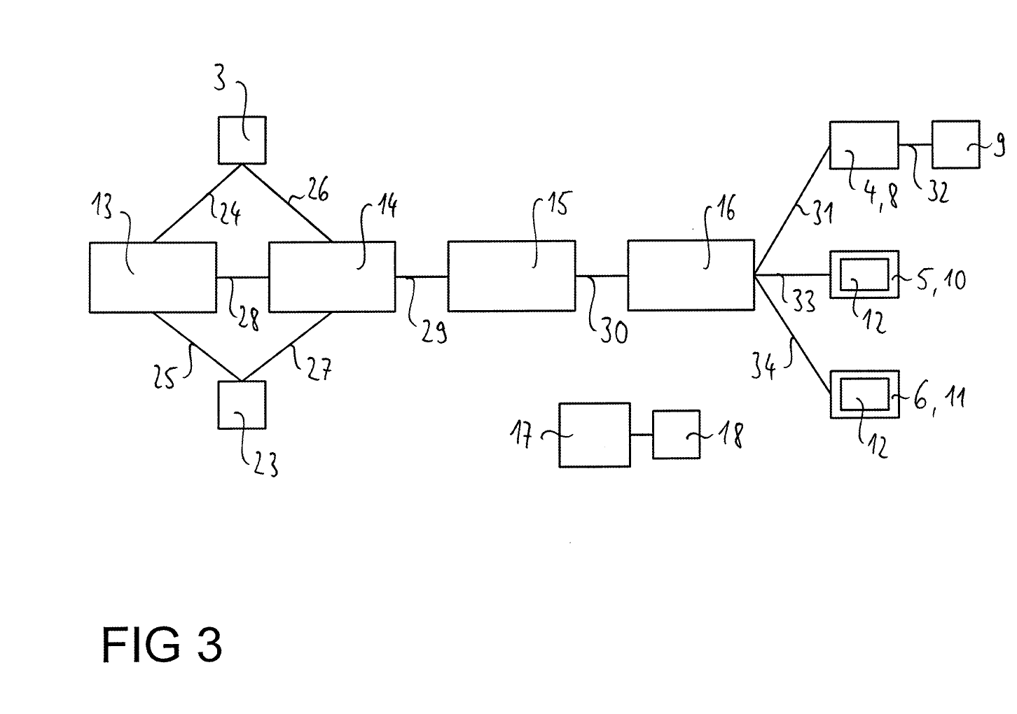

For this purpose, FIG. 3 shows details of the vehicle shown in FIG. 2. Components that have the same functions as in FIG. 2 are identified with the same reference signs, and will not be described again in the following text. For the sake of clarity, the vehicle is not shown in more detail in FIG. 3. In the embodiment shown, besides the at least one ultrasonic sensor 3 the vehicle also comprises at least one optical camera 23, which is also arranged inside the vehicle.

The vehicle also comprises a first determination device 13, which is designed to determine whether at least one occupant of the vehicle is moving at least one body part, based on data collected by the at least one ultrasonic sensor 3 and based on data collected by the at least one optical camera 23. For this purpose, first determination device 13 is connected to the at least one ultrasonic sensor 3 via a signal wire 24 and to the at least one optical camera 23 via a signal wire 25.

The vehicle also comprises a classification device 14, which is designed to classify the movement based on the data collected by the at least one ultrasonic sensor 3 and based on data collected by the at least one optical camera 23, if it is determined that at least one occupant of the vehicle is moving at least one body part. For this purpose, classification device 14 comprises for example a storage device, in which parameters and/or parameter profiles characterizing defined movement types are stored. In particular, data of exemplary movements may be stored in the storage device. Classification device 14 is connected to the at least one ultrasonic sensor 3 via a signal wire 26 and to the at least one optical camera 23 via a signal wire 27. Classification device 14 is also connected to first determination device 13 via a signal wire 28.

The vehicle further comprises a second determination device 15, which is designed to determine whether the movement corresponds to a predefined movement type from a plurality of predefined movement types. For this purpose, second determination device 15 comprises for example a storage device in which the predefined movement types are stored. Second determination device 15 is connected to classification device 14 via a signal wire 29.

The vehicle also comprises an adaptation device 16, which is designed to automatically adapt a plurality of components of the vehicle depending on the respective predefined movement type, if it is determined that the movement corresponds to a predefined movement type from a plurality of predefined movement types. For this purpose, adaptation device 16 is connected to second determination device 15 via a signal wire 30.

Adaptation device 16 is also connected to a component 4 of the vehicle via a signal wire 31, wherein component 4 is a driver assistance system 8 of the vehicle. In the embodiment shown, driver assistance system 8 is designed to automatically operate at least one element 9 of the vehicle selected from the group consisting of a braking device, a drive unit, a steering device and a warning device. For this purpose, driver assistance system 8 is connected to the at least one element 9 via a signal wire 32. The driver assistance unit is selected for example from the group consisting of an emergency braking system, a braking assistant, a lane tracking assistant and a collision warning system.

Adaptation device 16 is designed to adapt a threshold value of driver assistance system 8 for automatic actuation of the at least one element 9 in such manner that the automatic actuation is carried out at an earlier time. Adaptation device 16 is also connected to a further component 5 of the vehicle in the form of a control element 10 via a signal wire 33, and to a third component 6 in the form of a display element 11 via a signal wire 34.

In the embodiment shown, adaptation device 16 is designed to automatically adapt a luminosity of a first lighting device 12 of control element 10 and of a second lighting device 12 of display element 11. In the embodiment shown, adaptation device 16 also designed to automatically adapt a position of control element 10 and/or of display element 11 in the vehicle.

In the embodiment shown, the vehicle further includes a computing unit 17 and a computer-readable medium 18, wherein a software product is stored on the computer-readable medium which, when running on computing unit 17, instructs computing unit 17 to carry out the steps described in the context of the embodiments of the method according to the application, in particular the steps of the embodiment shown in FIG. 1, by means of the elements listed therein. For this purpose, computing unit 17 is connected directly or indirectly to the corresponding elements in a manner not shown in detail here.

In the embodiment shown, therefore, a system is provided that interprets particularly head, hand and/or body movements, for example turning of the head by the driver, based on an altered acoustic reflection behaviour using one or more ultrasonic sensors that are arranged inside the vehicle and are directed toward the driver, for example. The system uses the micro-Doppler effect or patterns in the reflected echo for example to evaluate changes in the echo characteristics, and interprets and classifies certain gestures made particularly by the driver.

These gestures include but are not limited to, for example, the driver turning his head to the left or right to look behind him, turning his head to the right toward the front seat passenger, glancing downward to a degree that involves moving the head, taking both hands off the steering wheel, gesticulating with one or both hands, and reaching into certain areas by either the driver or the front seat passenger, for example moving a hand toward a control button on a control console.

The system determines a changed position of the driver's head, for example, if the driver looks at another vehicle occupant or over his shoulder, and informs other systems in the vehicle about the position, so that they may be informed that the driver is not looking in the direction of travel. The other systems in the vehicle may also be informed that the driver is not looking in a certain direction that differs from the direction of travel, that the driver does not look behind when changing lanes, for example.

The system is typically taught the characteristics of each gesture. After this offline training step, the system interprets or classifies these gestures so that other systems, a driver assistance system for example, can be informed of these gestures, particularly the fact that the driver is not looking in the direction of travel. This enables warning and control behaviours to be adapted. For example, a collision warning is output sooner or an automatic braking manoeuvre is initiated earlier.

The system described used inexpensive ultrasonic sensors 3 in order to perform an evaluation particularly of the position of the driver's head in critical situations. This enables a better understanding of the driver's level of alertness. This represents an inexpensive way to determine when a driver is not fully alert, as he is not looking in the direction of travel, and assistance systems use this information and are adapted to these circumstances, for example by emitting an alarm sooner.

The use of acoustic signals also makes it possible to monitor the driver's activities without being constrained by the strict requirements imposed on the arrangement of the monitoring sensor, that is to say the at least one ultrasonic sensor is subject to fewer restrictions in the arrangement thereof than the at least one optical camera 23. Consequently, the system shown only uses inexpensive hardware components and enables the determination of important activities by the driver and of the driving behaviour, for example the driver's level of attention, which are an important input variable particularly for vehicle emergency braking systems.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A method for operating a vehicle, comprising:
determining whether an occupant of the vehicle is moving a body part based on data collected by an ultrasonic sensor arranged in the vehicle;
classifying a movement based on the data collected by the ultrasonic sensor and determining whether the movement corresponds to a predefined movement type from a plurality of predefined movement types if it is determined that at least one occupant of the vehicle is moving at least one body part; and
automatically adapting a component of the vehicle depending on the predefined movement type if it is determined that at the movement corresponds to the predefined movement type from the plurality of predefined movement types.

2. The method according to claim 1, wherein the determining as to whether the occupant of the vehicle is moving the body part comprises determining whether a driver of the vehicle is moving the body part.

3. The method according to claim 1, wherein the determining as to whether the occupant of the vehicle is moving the body part comprises interpreting a movement.

4. The method according to claim 1, wherein the determining as to whether the occupant of the vehicle is moving the body part is carried out with pattern recognition in the data collected by the ultrasonic sensor.

5. The method according to claim 1, wherein the determining as to whether the occupant of the vehicle is moving the body part comprises analysis of a chronological progression of a distance of the body part from ultrasonic sensor.

6. The method according to claim 1, wherein the automatically adapting of the component of the vehicle comprises automatically adapting of a driver assistance system of the vehicle.

7. The method according to claim 6,
wherein the driver assistance system is configured to automatically operate an element of the vehicle, and
wherein the automatically adaptating of the driver assistance system comprises modification of a threshold value for an automatic operation of the element in such manner that the automatic operation is effected sooner.

8. The method according to claim 6, wherein the driver assistance system is an emergency braking system.

9. The method according to claim 1, wherein the automatically adapting of the component of the vehicle comprises an automatically adapting of a control element and a display element of the vehicle.

10. The method according to claim 9, wherein the automatically adapting comprises automatically activating the control element.

11. The method according to claim 9, wherein the automatically adapting comprises automatically adapting of a luminosity of a lighting device of the control element.

12. The method according to claim 9, wherein the automatically adapting of a position of the control element and the display element.

13. A vehicle comprising
an ultrasonic sensor is disposed inside the vehicle;
a first analysis device that is configured to determine whether an occupant of the vehicle is moving a body part on a basis of the data collected by the ultrasonic sensor;
a classification device that is configured to classify a movement on a basis of the data collected by the ultrasonic device if it is determined that at least one occupant of the vehicle is moving at least one body part;
a second analysis device that is configured to determine whether the movement corresponds to a predefined movement type from a plurality of predefined movement types; and
an adaptation device that is configured to automatically adapt a component of the vehicle depending on the predefined movement type, if it is determined that the movement corresponds to the predefined movement type from the plurality of predefined movement types.

14. (canceled)

15. (canceled)
